(19) United States
(12) Patent Application Publication
(10) Pub. No.: US 2026/0198398 A1
(43) Pub. Date: Jul. 16, 2026

(54) METHOD AND UTILITY VEHICLE FOR DETERMINING HEIGHT POSITION FOR POWER LIFT

(71) Applicant: DEERE & COMPANY, MOLINE, IL (US)

(72) Inventors: Lucas A. Schreieck, Haßloch (DE); Brandon J. MCMILLEN, Cedar Falls, IA (US); Narendra Arjun Aher, PUNE (IN); Saurav Dutta, PUNE (IN); Sandeep Thiruvalluvan, PUNE (IN)

(21) Appl. No.: 19/374,051

(22) Filed: Oct. 30, 2025

(30) Foreign Application Priority Data
Jan. 13, 2025 (EP) 25151456.8

(51) Int. Cl. A01B 63/02; A01B 76/00

(52) U.S. Cl. CPC A01B 63/02; A01B 76/00

(57) ABSTRACT

The disclosure relates to a method for determining a height position that is to be set for a power lift mounted on a utility vehicle and coupled to an attachment for soil cultivation. A force sensor is used to determine an actual tractive force acting on the power lift. An additional sensor is used to determine at least one soil parameter of the soil that has been cultivated or is to be cultivated. The height position that is to be set is determined based on the actual tractive force and the at least one soil parameter. The disclosure also relates to a utility vehicle having a control unit for carrying out such a method.

### CROSS-REFERENCE TO RELATED APPLICATIONS

This application claims the priority benefit of EP 25151456.8 filed on 13-January-2025. All of the above applications are incorporated by reference herein and are to be considered a part of this specification. Any and all applications for which foreign or domestic priority claim is identified in the Application Data Sheet as filed with the present application are hereby incorporated.

### TECHNICAL FIELD

The disclosure generally relates to a method and to a utility vehicle for determining a height position that is to be set for a power lift that is mounted on the utility vehicle and is coupled to an attachment for soil cultivation.

### BACKGROUND

In agriculture, various attachments are used for soil cultivation. In many cases, the attachment is coupled to a power lift, which is mounted on the tractor so as to be adjustable in height. The attachment is indirectly maintained at a desired working depth by detecting a tractive force on the tractor and a suitable controller for setting the height position of the power lift. Depending on the respective soil conditions, the height position of the power lift can also be additionally corrected by an operator or the driver of the tractor.

### SUMMARY

The disclosure is based on the object of improving a controller for setting the height position of the power lift during the soil cultivation. This object is achieved by a method having the features one or more embodiments disclosed herein and by a utility vehicle having the features of one or more embodiments disclosed herein.

According to one or more embodiments disclosed herein, a method is proposed for determining a height position that is to be set for a power lift that is mounted on a utility vehicle and coupled to an attachment for soil cultivation (for example a plow, harrow). In this case, a force sensor is used to detect an actual tractive force currently acting on the power lift. An environment sensor is used to detect at least one soil parameter of the soil that has been cultivated or is to be cultivated. The height position for the power lift is determined in dependence on the actual tractive force detected and the at least one soil parameter detected. The power lift can then be set at the determined height position in a suitable manner (for example by actuating a lifting cylinder of the power lift). The determined height position can be considered to be a target height position, which is set by means of suitable actuation, for the power lift. For this purpose, for example, provision is made for a control unit, which determines the target height positions and actuates the power lift, for example the lifting cylinder already mentioned, in order to set or implement these target height positions.

Taking into account the data or sensor signals from an additional sensor provides data-efficient support for a control or regulation system for more precisely determining the height position that is to be set during the soil cultivation. The determination of at least one soil parameter can in this case help to avoid undesired changes in the height position. For example, this enables a controller to recognize that, despite changes in the soil parameter (for example different soil conditions of clay, loam, sand) and corresponding changes in the actual tractive force, a change in the height position is undesired if the surface of the field is uniformly level or flat and the working depth of the attachment is intended to remain constant. Since undesired changes in the height positions are avoided, the manual effort on the part of a user or the driver for correcting to the desired height position is also reduced. The method consequently makes the soil cultivation more user-friendly and more comfortable.

For instance, the at least one soil parameter comprises a soil contour, a topography of the soil and/or a soil inclination. The one or more soil parameters may represent, for example, a surface profile (for example inclination, gradient, curvature) in the region of the soil to be cultivated (for example directly in front of the attachment, the power lift or the utility vehicle) and/or of the already cultivated soil (for example directly behind the attachment, the power lift or the utility vehicle). Taking into account the at least one soil parameter supports correct control behavior with respect to determining and setting the most appropriate height position for the power lift.

Further, the at least one soil parameter is determined in dependence on vehicle-related sensor data from the additional sensor. This enables the soil parameters to be derived from vehicle-related sensor data from the utility vehicle with low technical effort. Vehicle-related sensor data are available in any case as standard at the utility vehicle, for example at its data bus and/or control bus (for example ISO, CAN), so that the soil parameters of interest can be determined without additional technical effort. Relevant vehicle-related sensor data for determining the at least one soil parameter are, for example, an angular position and/or an orientation and/or a position of the utility vehicle with respect to a horizontal and/or another reference line. The additional sensor is, for example, in the form of an inertial measurement unit (IMU).

During the soil cultivation, the actual tractive force is determined and thus a change in the actual tractive force can also be detected or determined. In this case, the change in the actual tractive force and the one or more soil parameters can be expediently linked mathematically or algorithmically in order to determine the height position that is to be set.

In an embodiment, the change in the actual tractive force is weighted differently in dependence on the at least one soil parameter determined, in order to determine the height position of the power lift. The dependence of the height position that is to be set on the changing actual tractive forces can thus be adapted in a physically expedient manner to different soil conditions (for example soil types, soil inclination).

The different weighting can be represented, for example in a formula or an algorithm for determining the height position, by a weighting factor with different numerical values. These numerical values are dependent on the at least one soil parameter determined or on the values thereof. The weighting factor can thus be defined with respect to its numerical values in such a manner that it enables the height position of the power lift to be efficiently and precisely corrected or set again in the case of varying soil conditions.

The different weighting for the changed actual tractive force is expedient as a soil parameter, for example, in conjunction with a determined soil inclination. In this case, it is advantageous if the weighting is greater in the case of a determined soil inclination m ≠ 0 than in the case of a determined soil inclination m = 0. In this way, the determined soil inclination has a significant influence on whether and to what extent the height position of the power lift should be changed in the case of a changed actual tractive force. This enables undesired changes in the height position and thus in the working depth to be avoided with low technical effort. This supports precise soil cultivation under different soil conditions. For example, in the case of a determined soil inclination m = 0, despite a changed actual tractive force, the height position of the power lift should remain unchanged, this being possible with a correspondingly defined weighting of the changed actual tractive force in dependence on the soil inclination. This enables undesired changes in the working depth or the height position of the power lift in the case of level terrain to be automatically avoided despite different or varying soil types (for example clay, loam, sand).

The disclosure also relates to a utility vehicle having a power lift that is mounted thereon and is coupled to an attachment for soil cultivation. The utility vehicle has a force sensor for determining an actual tractive force acting on the power lift. The utility vehicle also has an additional sensor for determining at least one soil parameter of the soil that has been cultivated or is to be cultivated. A control unit of the utility vehicle determines a height position that is to be set for the power lift in dependence on the actual tractive force and the at least one soil parameter.

The utility vehicle according to the disclosure has the above-described advantages of the method according to the disclosure. In this case, adapting the height position in dependence on soil parameters makes it possible to support precise soil cultivation and to avoid undesired changes in the working depth of the attachment with low technical effort. For example, even in the case of topographical irregularities, a working depth of the attachment that is as constant as possible can be maintained with a lower or no manual correction effort at all. This enables the operator or the driver of the utility vehicle to be unburdened during the soil cultivation.

The additional sensor may be in the form of an inertial measurement unit (IMU). This measurement unit helps, by way of its sensor data, to make it possible to determine, for example, an acceleration, an angular velocity and an orientation of the additional sensor. Since this measurement unit is arranged on the utility vehicle, vehicle-related sensor data such as, for instance, a position, angular position or orientation of the utility vehicle (for example relative to a horizontal) can be obtained as a result. The at least one soil parameter can be determined in dependence on these sensor data. The above-mentioned inertial measurement unit is often present as standard on the utility vehicle (for example a tractor) and therefore supports precise determination of the desired height position for the power lift in many cases without additional technical effort.

The power lift is constructed, for example, as a three-point power lift. The power lift is in the form of a rear power lift, which, mounted in the rear region of the utility vehicle, can be used for efficient soil cultivation.

The utility vehicle may be an agricultural utility vehicle, for example, a tractor, which is combined with a power lift and an attachment for soil cultivation (for example in a field or meadow). Soil cultivation includes, for example, plowing the soil or preparing soil for planting seed or plants, for example flower bulbs, at a precise depth.

### BRIEF DESCRIPTION OF THE DRAWINGS

The disclosure will be explained in more detail in the following text with reference to the appended drawings. Components with an equivalent or comparable function are identified here by the same reference signs.

FIG. 1 shows a schematic side view of a utility vehicle according to the disclosure with a power lift mounted thereon.

FIG. 2 shows a schematic side view of the utility vehicle according to the disclosure on hilly terrain.

FIG. 3 shows an illustration in the manner of a block diagram with a control unit for actuating the power lift.

FIG. 4 shows another illustration in the manner of a block diagram with the control unit for actuating the power lift.

### DETAILED DESCRIPTION

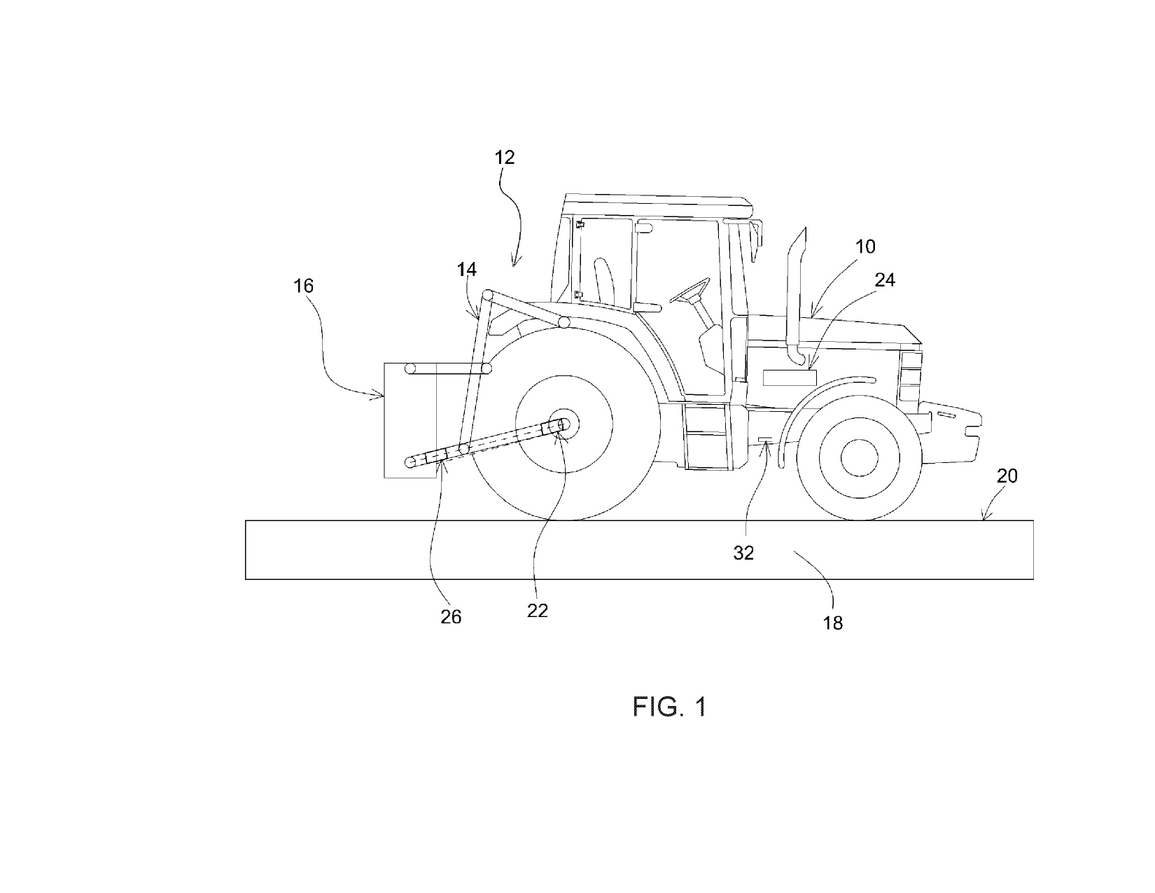

FIG. 1 shows an agricultural utility vehicle 10 in the form of a tractor with a power lift 14 or rear power lift mounted in the rear region 12 thereof. The power lift 14 is coupled to an attachment 16 (illustrated only schematically here) for soil cultivation (for example a plow, harrow). Soil cultivation includes, for example, the creation of a furrow in the soil 18 of an agricultural field 20 with a uniform furrow depth for the planting of seed or plants.

A force sensor 22, which detects an actual tractive force F_sen currently acting on the utility vehicle 10 or on the power lift 14, is arranged on the power lift 14. The actual tractive force F_sen represents a mechanical resistance of the soil 18 to the attachment 16 or the power lift 14. The signals from the force sensor 22 are fed to a control unit 24 of the utility vehicle 10, said control unit actuating the power lift 14, for example, an actuator (for example lifting cylinder) of the power lift 14 in dependence on the signals from the force sensor 22 and further signals that will be described below. Thus, the respective height position pos_h of the power lift 14 can be determined and set by the control unit 24. In this case, the control unit 24 accesses, inter alia, the sensor data from a position sensor 26 arranged on the utility vehicle 10, for example, on the power lift 14.

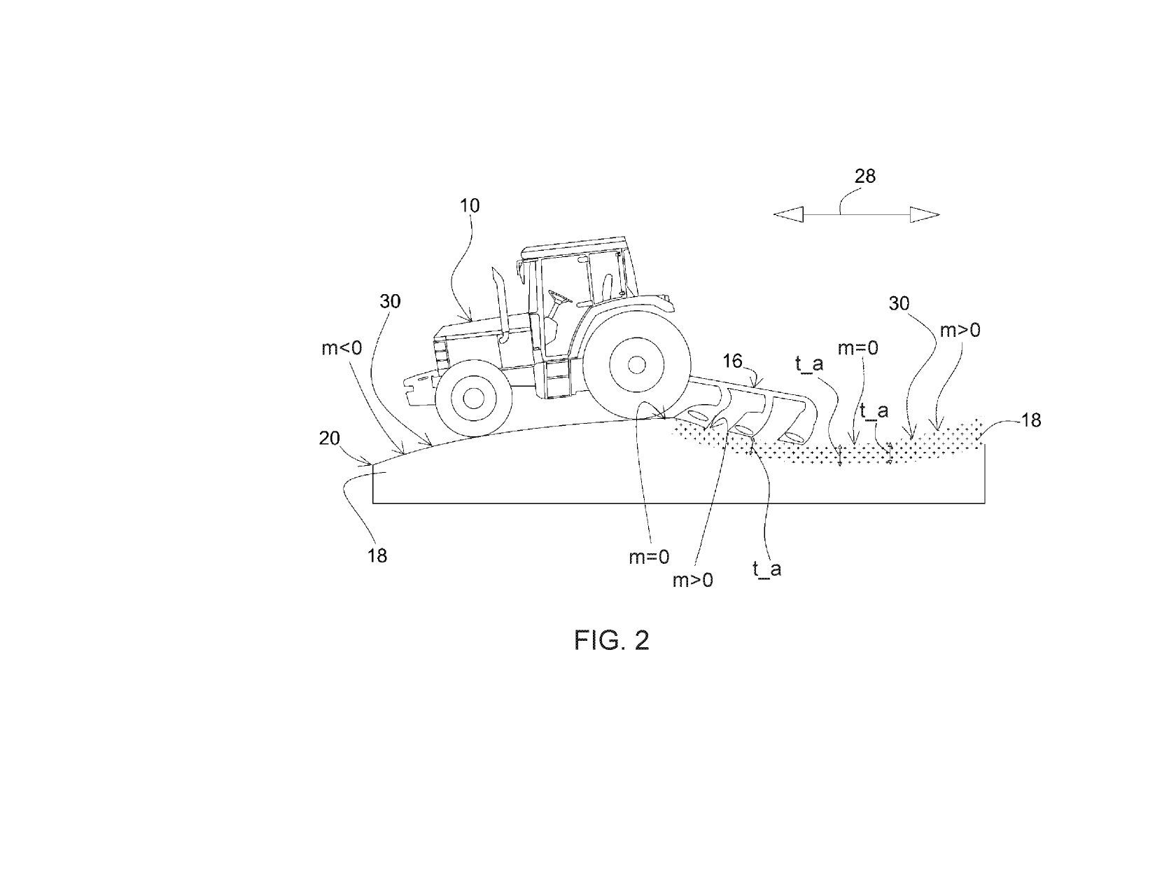

FIG. 2 shows the utility vehicle 10 or the tractor driving over hilly terrain in the form of an agricultural field 20. The hilly terrain is characterized by a soil contour 30 that varies with respect to a horizontal 28 or by a varying surface profile. In other words, the soil contour 30 has different soil inclinations m. By way of example, directly in front of the utility vehicle 10 in the direction of travel, the soil inclination m < 0, while directly behind the utility vehicle 10, the soil inclination m > 0. At other points on the soil contour 30, the soil inclination m = 0. At these points, the soil contour 30 is approximately parallel to the horizontal 28.

FIG. 2 indicates that, despite the irregular soil contour 30 and/or despite varying soil conditions or soil types (for example clay, loam, sand) in the agricultural field 20 to be cultivated, the aim is to achieve a working depth t_a that is uniform or as constant as possible.

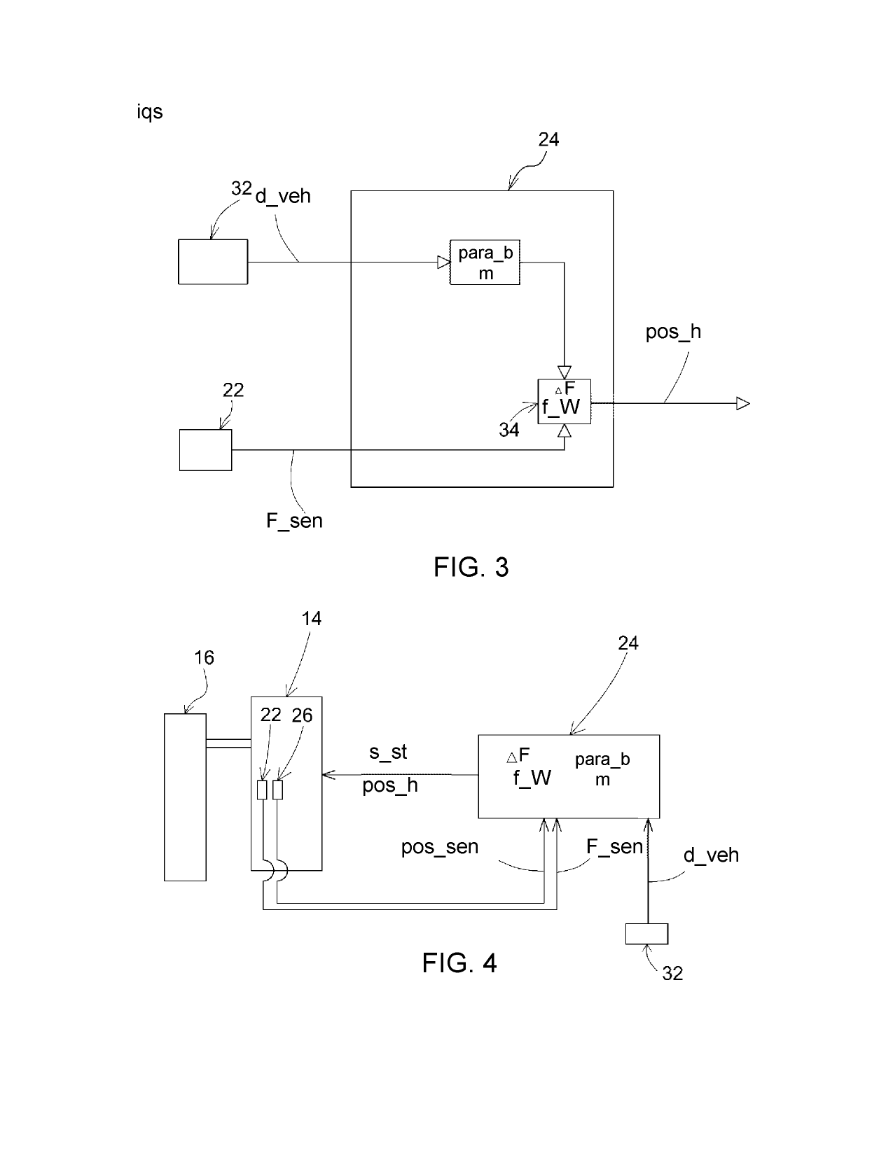

For this purpose, the control unit 24 also processes, in addition to the sensor data from the force sensor 22, inter alia, sensor data from an additional sensor 32 (FIG. 3). The additional sensor 32 is in the form of an inertial measurement unit (IMU), which is arranged on the utility vehicle 10 and generates vehicle-related sensor data d_veh. These sensor data d_veh represent, for example, an angular position and/or an orientation and/or a position of the utility vehicle 10 with respect to the horizontal 28 and/or another reference line. On the basis of the vehicle-related sensor data d_veh, at least one soil parameter para_b is derived or determined in the control unit 24. The soil parameters para_b used are, for example, the soil contour 30 and/or the soil inclination m and/or other features of the agricultural field 20.

The at least one soil parameter para_b and the actual tractive force F_sen determined are processed in the control unit 24 – optionally taking into account further data – in order to determine the height position pos_h that is currently to be set for the power lift 14.

In an embodiment, the at least one soil parameter para_b and the actual tractive force F_sen determined are processed in a control algorithm 34 of the control unit 24. The control algorithm 34 can determine or calculate the height position pos_h. In this case, for the determination of the height position pos_h that is to be set, an established change ∆F in the actual tractive force F_sen can be weighted differently in dependence on the at least one soil parameter para_b determined.

The weighting of the change ∆F in the actual tractive force F_sen can be represented by a weighting factor f_W. The value of the weighting factor f_W is dependent on the at least one soil parameter para_b determined. For instance, the value of the weighting factor f_W is greater in the case of a determined soil inclination m ≠ 0 than in the case of a determined soil inclination m = 0. In other words, the influence of changes in the actual tractive force F_sen on the determination of the height position pos_h in a non-level field 20 is greater than in a flat, in particular approximately horizontally running field 20. This makes it possible to avoid, from the outset, supposedly required changes in the height position pos_h, which would then have to be manually corrected again. For example, on a level field 20 with a soil inclination m = 0, despite a registered change ∆F in the actual tractive force F_sen, a change in the height position pos_h is undesired in most applications because then the desired constant working depth t_a would no longer be adhered to. For such cases, the weighting factor f_W = 0 can be defined, so that a change ∆F in the actual tractive force F_sen does not generate a changed height position pos_h.

FIG. 4 shows the control unit 24 with different input and output signals, in dependence on which the power lift 14, in particular an actuator (for example a hydraulic lifting cylinder), is actuated in order to set the determined height position pos_h.

In general, the control unit 24 generates control signals s_st as output signals in order to actuate the power lift 14 so as to set the determined height position pos_h.

Effective input signals are, inter alia, the signals or data F_sen from the force sensor 22 and signals or data pos_sen from the position sensor 26 in the region of the power lift 14. The additional sensor 32 also supplies input signals in the form of the sensor data d_veh for the control unit 24. Further input signals for the control unit 24 may be generated by one or more operating elements (not illustrated here). Such operating elements (for example a rotationally movable operating wheel) can be provided in order, for example, to give the operator or the driver of the utility vehicle 10 the possibility, during soil cultivation, of changing specific settings (for example gradient of a characteristic curve, manual specification of a target height position) in conjunction with the determination of the height position pos_h.

Those having ordinary skill in the art will recognize that terms such as “above,” “below,” “upward,” “downward,” “top,” “bottom,” etc., are used descriptively for the FIG., and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

What is claimed is:

1. A method for determining a height position that is to be set for a power lift mounted on a utility vehicle and coupled to an attachment for soil cultivation, the method comprising:
determining, via a force sensor, an actual tractive force acting on the power lift,
determining, via an additional sensor, at least one soil parameter of the soil that has been cultivated or is to be cultivated, and
determining the height position that is to be set in dependence on the actual tractive force and the at least one soil parameter.

2. The method of claim 1, wherein the at least one soil parameter includes a soil contour or a soil inclination.

3. The method of claim 1, wherein the at least one soil parameter is determined based on vehicle-related sensor data from the additional sensor.

4. The method of claim 1, wherein a change in the actual tractive force for determining the height position that is to be set is weighted differently based on the at least one soil parameter.

5. The method of claim 4, wherein the weighting of the change in the actual tractive force is represented by a weighting factor, the value of which is based on the at least one soil parameter.

6. The method of claim 4, wherein the weighting of the change in the actual tractive force is greater in the case of a determined soil inclination not equal to zero than in the case of a determined soil inclination equal to zero.

7. A utility vehicle having a power lift that is mounted thereon and is coupled to an attachment for soil cultivation, the utility vehicle comprising:
a force sensor for determining an actual tractive force acting on the power lift,
an additional sensor for determining at least one soil parameter of the soil that has been cultivated or is to be cultivated, and
a control unit for determining a height position that is to be set for the power lift based on the actual tractive force and the at least one soil parameter.

8. The utility vehicle of claim 7, wherein the additional sensor is in the form of an inertial measurement unit.

9. The utility vehicle of claim 7, wherein the power lift is in the form of a rear power lift.

10. The utility vehicle of claim 7, wherein the utility vehicle is an agricultural utility vehicle.
